(19) United States
(12) Patent Application Publication
(10) Pub. No.: US 2021/0331497 A1
(43) Pub. Date: Oct. 28, 2021

(54) INKJET RECORDING DEVICE

(71) Applicant: KYOCERA Document Solutions Inc, Osaka-shi (JP)

(72) Inventor: Shigeharu ITO, Osaka-shi (JP)

(21) Appl. No.: 17/233,959

(22) Filed: Apr. 19, 2021

(30) Foreign Application Priority Data
Apr. 22, 2020 (JP) 2020-076363

(51) Int. Cl. B41J 13/00

(52) U.S. Cl. CPC B41J 13/0009

(57) ABSTRACT

A control unit in an inkjet recording device controls a drive roller to stop a conveyance belt such that, after completion of a print job, a reference specifying portion of the conveyance belt is stopped at a position on an upstream side in a conveyance direction of the conveyance belt from a detecting position of a reference detection sensor by a particular distance or longer. The particular distance is a distance, for which the conveyance belt moves until the conveyance belt reaches a specific conveyance speed after the conveyance belt in a stopped state starts moving by driving of the drive roller.

### INCORPORATION BY REFERENCE

This application is based upon, and claims the benefit of priority from, corresponding Japanese Patent Application No. 2020-076363 filed in the Japan Patent Office on Apr. 22, 2020, the entire contents of which are incorporated herein by reference.

### BACKGROUND

### Field of the Invention

The present disclosure relates to an inkjet recording device.

### Description of Related Art

Typically, in an inkjet recording device such as an inkjet printer, flushing (empty ejection) is conducted to periodically eject ink from a nozzle in order to reduce or prevent clogging of the nozzle caused by drying of the ink. For example, an opening is provided to a conveyance belt that conveys a recording medium, and flushing is conducted when the opening reaches a position facing a recording head due to movement of the conveyance belt. The ink that is ejected from the nozzle in the recording head during flushing passes through the opening of the conveyance belt and is collected by an ink receiving member. The conveyance belt is provided with a mark for detection of the opening, and flushing is conducted with the detection of the mark as a trigger.

### SUMMARY

An inkjet recording device according to one aspect of the present disclosure includes: a recording head that has a plurality of nozzles for ejecting ink; an endless conveyance belt that conveys a recording medium to a position facing the recording head and has a reference specifying portion indicative of a reference of one round of the belt; a drive roller that causes the conveyance belt to move in a conveyance direction of the recording medium; a recording medium supply unit that supplies the recording medium onto the conveyance belt; a reference detection sensor that detects the reference specifying portion; and a control unit that controls the drive roller and the recording medium supply unit. The control unit controls the drive roller to stop the conveyance belt such that, after completion of a print job in which an image is formed by ejecting the ink to the recording medium from the recording head, the reference specifying portion of the conveyance belt is stopped at a position on an upstream side in the conveyance direction of the conveyance belt from a detecting position of the reference detection sensor by a particular distance or longer. The particular distance is a distance for which the conveyance belt moves until the conveyance belt reaches a specific conveyance speed since the conveyance belt in a stopped state starts moving by driving of the drive roller.

### BRIEF DESCRIPTION OF THE DRAWINGS

FIG. 1 is an explanatory view illustrating a schematic configuration of a printer as an inkjet recording device according to an embodiment of the present disclosure;

FIG. 2 is a plan view of a recording unit provided in the printer;

FIG. 3 is an explanatory view schematically illustrating a configuration around a paper conveyance path from a paper-feed cassette in the printer to a second conveying unit via a first conveying unit;

FIG. 4 is a block diagram illustrating a hardware configuration of main units of the printer;

FIG. 5 is a plan view illustrating a configuration example of a first conveyance belt provided in the first conveying unit;

FIG. 6 is an explanatory view schematically illustrating an exemplary pattern of an opening group for flushing at the time of using the first conveyance belt in FIG. 5, and paper that is placed on the first conveyance belt according to the pattern;

FIG. 7 is an explanatory view schematically illustrating another example of the pattern and the paper that is placed on the first conveyance belt according to the pattern;

FIG. 8 is an explanatory view schematically illustrating further another example of the pattern and the paper that is placed on the first conveyance belt according to the pattern;

FIG. 9 is an explanatory view schematically illustrating yet another example of the pattern and the paper that is placed on the first conveyance belt according to the pattern;

FIG. 10 is an explanatory view schematically illustrating an exemplary position of a reference specifying portion in a stopped state of the first conveyance belt after completion of a print job;

FIG. 11 is an explanatory view schematically illustrating the position of the reference specifying portion at a time point at which the first conveyance belt reaches a specific conveyance speed after the first conveyance belt starts moving in the stopped state illustrated in FIG. 10;

FIG. 12 is an explanatory view schematically illustrating another exemplary position of the reference specifying portion in the stopped state of the first conveyance belt after the completion of the print job;

FIG. 13 is an explanatory view schematically illustrating further another exemplary position of the reference specifying portion in the stopped state of the first conveyance belt after the completion of the print job;

FIG. 14 is an explanatory view schematically illustrating the position of the reference specifying portion at a time point at which the first conveyance belt reaches the specific conveyance speed after the first conveyance belt starts moving in the stopped state illustrated in FIG. 3;

FIG. 15 is a plan view schematically illustrating another configuration of the first conveyance belt;

FIG. 16 is a plan view schematically illustrating further another configuration of the first conveyance belt; and

FIG. 17 is a plan view schematically illustrating yet another configuration of the first conveyance belt.

### DETAILED DESCRIPTION

[1. Configuration of Inkjet Recording Device]

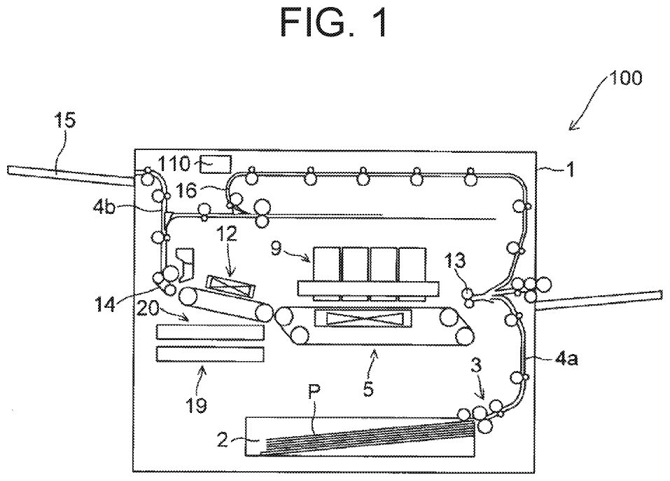

A description will hereinafter be made on an embodiment of the present disclosure with reference to the drawings. FIG. 1 is an explanatory view illustrating a schematic configuration of a printer 100 as an inkjet recording device according to the embodiment of the present disclosure. The printer 100 includes a paper-feed cassette 2 as a paper storage unit. The paper-feed cassette 2 is arranged in a lower portion of a printer body 1. Paper P as an example of a recording medium is stored in the paper-feed cassette 2.

A paper feeder 3 is arranged on a downstream side in a paper conveyance direction of the paper-feed cassette 2, that is, at a position on an upper right side of the paper-feed cassette 2 in FIG. 1. This paper feeder 3 separates the paper P per sheet and feeds the paper P upward to the right of the paper-feed cassette 2 in FIG. 1.

The printer 100 includes a first paper conveyance path 4a therein. The first paper conveyance path 4a is located on the upper right side of the paper-feed cassette 2 in a paper-feed direction thereof. The paper P, which is fed out of the paper-feed cassette 2, is conveyed perpendicularly upward on the first paper conveyance path 4a along a side surface of the printer body 1.

A resist roller pair 13 is provided at a downstream end of the first paper conveyance path 4a in a paper conveyance direction. Furthermore, a first conveying unit 5 and a recording unit 9 are arranged in the immediate vicinity on a downstream side in the paper conveyance direction of the resist roller pair 13. The paper P, which is fed out of the paper-feed cassette 2, reaches the resist roller pair 13 through the first paper conveyance path 4a. The resist roller pair 13 measures timing of ink ejection operation performed by the recording unit 9 while correcting diagonal feed of the paper P, and feeds the paper P toward the first conveying unit 5 (particularly, a first conveyance belt 8, which will be described below). That is, the resist roller pair 13 constitutes a recording medium supply unit that supplies the paper P onto the first conveyance belt 8.

The paper P that is fed to the first conveying unit 5 by the resist roller pair 13 is conveyed by the first conveyance belt 8 to a position facing the recording unit 9 (particularly, recording heads 17a to 17c, which will be described below). Ink is ejected onto the paper P from the recording unit 9, and an image is thereby recorded on the paper P. At this time, the ink ejection in the recording unit 9 is controlled by a control unit 110 in the printer 100. The control unit 110 is configured to include a central processing unit (CPU), for example, and has functions as a calculation unit that performs necessary calculations and a timekeeping unit that clocks time.

In the paper conveyance direction, a second conveying unit 12 is arranged on a downstream side (left side in FIG. 1) of the first conveying unit 5. The paper P, on which the image is recorded by the recording unit 9, is conveyed to the second conveying unit 12. The ink ejected onto a surface of the paper P is dried while passing through the second conveying unit 12.

In the paper conveyance direction, a decurler unit 14 is provided at a position on a downstream side of the second conveying unit 12 and near a left surface of the printer body 1. The paper P, on which the ink is dried by the second conveying unit 12, is conveyed to the decurler unit 14, and the paper P is uncurled.

In the paper conveyance direction, a second paper conveyance path 4b is provided on a downstream side (upper side in FIG. 1) of the decurler unit 14. When double-sided recording is not conducted, the paper P, which has passed through the decurler unit 14, passes through the second paper conveyance path 4b and is discharged to a paper exit tray 15 that is provided on the outside of a left surface of the printer 100.

A reversing conveyance path 16 for the double-sided recording is provided at a position in an upper portion of the printer body 1 and above the recording unit 9 and the second conveying unit 12. When the double-sided recording is conducted, the paper P, recording on one surface (a first surface) of which is completed, and which has passed through the second conveying unit 12 and the decurler unit 14, is conveyed to the reversing conveyance path 16 through the second paper conveyance path 4b.

A conveyance direction of the paper P, which has been conveyed to the reversing conveyance path 16, is switched for subsequent recording on the other surface (a second surface) of the paper P. Then, the paper P passes through the upper portion of the printer body 1, is conveyed rightward, and is conveyed again to the first conveying unit 5 in a state where the second surface faces upward via the resist roller pair 13. In the first conveying unit 5, the paper P is conveyed to the position facing the recording unit 9, and an image is recorded on the second surface by the ink ejection from the recording unit 9. The paper P after the double-sided recording is discharged to the paper exit tray 15 via the second conveying unit 12, the decurler unit 14, and the second paper conveyance path 4b in this order.

A maintenance unit 19 and a cap unit 20 are arranged below the second conveying unit 12. The maintenance unit 19 moves horizontally at a position below the recording unit 9 when purging, wipes the ink pushed out of an ink ejection port of the recording head, and collects the wiped ink. Purging refers to operation to forcibly push out the ink from the ink ejection port of the recording head in order to discharge thickened ink, a foreign substance, or air bubbles in the ink ejection port. The cap unit 20 moves horizontally at the position below the recording unit 9 when capping an ink ejection surface of the recording head, further moves upward, and is mounted on a lower surface of the recording head.

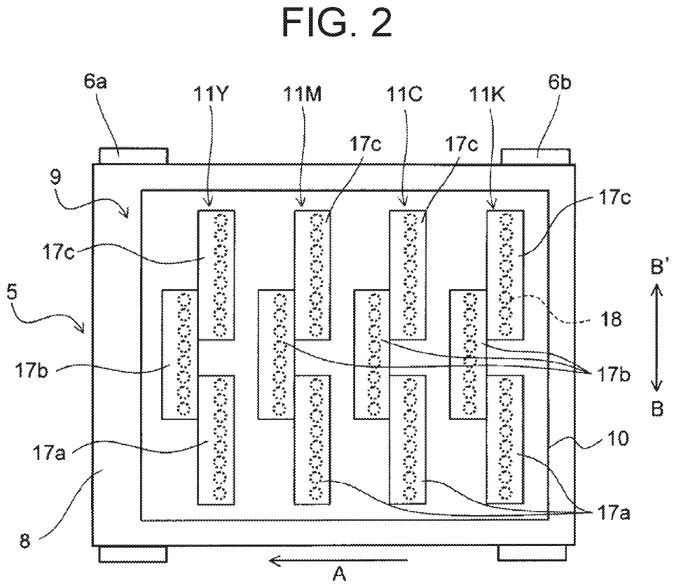

FIG. 2 is a plan view of the recording unit 9. The recording unit 9 includes a head housing 10 and line heads 11Y, 11M, 11C, 11K. The line heads 11Y to 11K are held by a head housing 10 in such a height that is provided with a specific clearance (for example, 1 mm) from a conveyance surface of the endless first conveyance belt 8 that is stretched around a plurality of rollers including a drive roller 6a, a driven roller 6b, and tension rollers 7a, 7b. The drive roller 6a causes the first conveyance belt 8 to move in the conveyance direction of the paper P (an arrow A direction). Driving of this drive roller 6a is controlled by the control unit 110. The plurality of rollers are arranged in an order of the tension roller 7a, the tension roller 7b, the driven roller 6b, and the drive roller 6a along a moving direction of the first conveyance belt 8.

The line heads 11Y to 11K each have the plurality of (three herein) recording heads 17a to 17c. The recording heads 17a to 17c are arranged in a staggered manner along a paper width direction (an arrow BB′ direction) that is orthogonal to the paper conveyance direction (the arrow A direction). Each of the recording heads 17a to 17c has a plurality of ink ejection ports 18 (nozzles). The ink ejection ports 18 are aligned at equally-spaced intervals in a width direction of the recording head, that is, the paper width direction (the arrow BB′ direction). The ink in each color of yellow (Y), magenta (M), cyan (C), and black (K) is ejected onto the paper P that is conveyed on the first conveyance belt 8 from respective one of the line heads 11Y to 11K via the ink ejection ports 18 of the recording heads 17a to 17c.

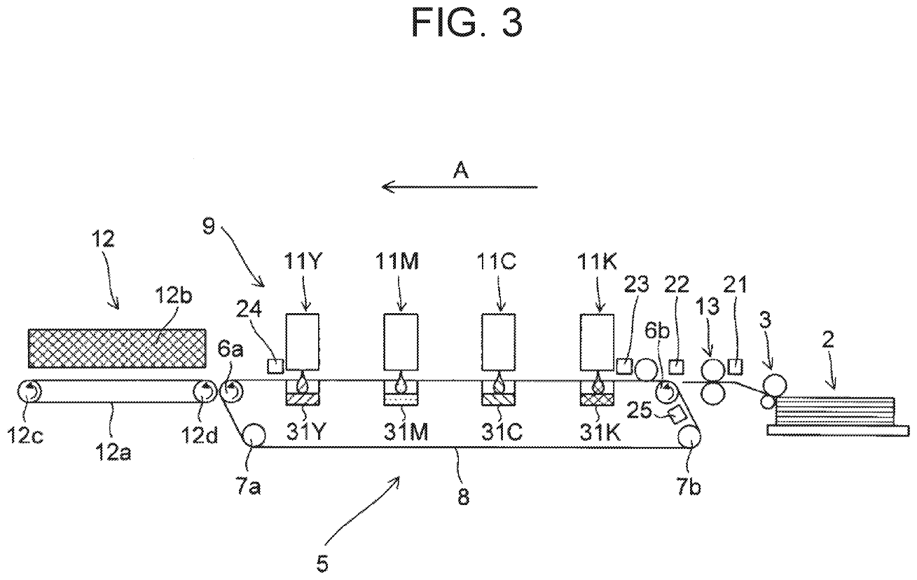

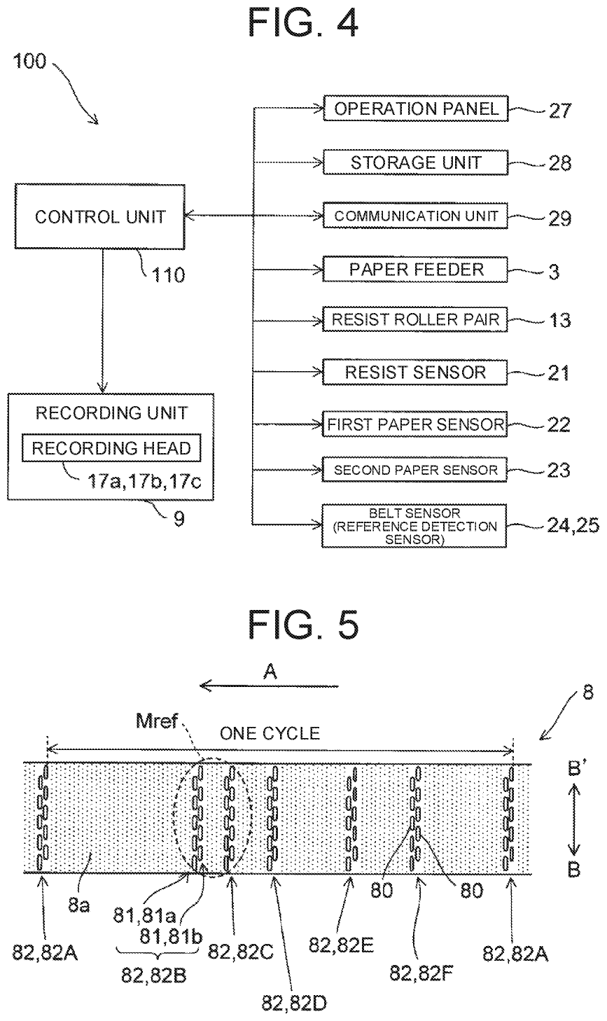

FIG. 3 schematically illustrates a configuration around the conveyance path of the paper P from the paper-feed cassette 2 to the second conveying unit 12 via the first conveying unit 5. FIG. 4 is a block diagram illustrating a hardware configuration of main units of the printer 100. In addition to the above components, the printer 100 further includes a resist sensor 21, a first paper sensor 22, a second paper sensor 23, and belt sensors 24, 25.

The resist sensor 21 detects the paper P that is conveyed from the paper-feed cassette 2 by the paper feeder 3 and is fed to the resist roller pair 13. This resist sensor 21 is located on the upstream side of the resist roller pair 13 in a supply direction of the paper P. The control unit 110 can control rotation start timing of the resist roller pair 13 on the basis of a detection result by the resist sensor 21. For example, based on the detection result by the resist sensor 21, the control unit 110 can control supply timing of the paper P to the first conveyance belt 8 after skew (incline) correction by the resist roller pair 13.

The first paper sensor 22 detects a position in the width direction of the paper P that is conveyed from the resist roller pair 13 to the first conveyance belt 8. Based on a detection result by the first paper sensor 22, the control unit 110 can cause the ink ejection ports 18, which correspond to the width of the paper P, among the ink ejection ports 18 in the recording heads 17a to 17c of the line head 11Y to 11K to eject the ink so as to record the image on the paper P.

The second paper sensor 23 detects passing of the paper P that is supplied to the first conveyance belt 8 by the resist roller pair 13. That is, the second paper sensor 23 detects the position in the conveyance direction of the paper P that is conveyed by the first conveyance belt 8. The second paper sensor 23 is located at a position that is on an upstream side of the recording unit 9 and on a downstream side of the first paper sensor 22 in the paper conveyance direction. Based on the detection result by the second paper sensor 23, the control unit 110 can control the ink ejection timing onto the paper P that reaches a position facing the line heads 11Y to 11K (the recording heads 17a to 17c) by the first conveyance belt 8.

Each of the belt sensors 24, 25 is a reference detection sensor that detects a reference specifying portion Mref (see FIG. 5) provided to the first conveyance belt 8. The reference specifying portion Mref is a portion indicative of a reference for one round of the first conveyance belt 8, and is configured to include a combination of two adjacent opening groups 82 or a reference mark that corresponds to at least one of the opening groups 82 as will be described below.

The belt sensor 24 is located on a downstream side of the recording unit 9 in the paper conveyance direction (the moving direction of the first conveyance belt 8). The belt sensor 25 is located on the upstream side in the paper conveyance direction of the driven roller 6b, on which the first conveyance belt 8 is stretched. In this embodiment, the belt sensor 25 is located between the driven roller 6b and the tension roller 7b, but may be located between the tension roller 7a and the tension roller 7b. The driven roller 6b is located on an upstream side of the recording unit 9 in the moving direction of the first conveyance belt 8. The belt sensor 24 has an equivalent function to the second paper sensor 23. Based on the detection result by the belt sensor 24 or 25, the control unit 110 can control the resist roller pair 13 in a manner to supply the paper P to the first conveyance belt 8 at specific timing.

Furthermore, the position of the paper is detected by the plurality of sensors (the second paper sensor 23 and the belt sensor 24), and the reference specifying portion Mref of the first conveyance belt 8 is detected by the plurality of sensors (the belt sensors 24, 25). In this way, it is also possible to correct an error in the detected position and to detect abnormality.

Each of the first paper sensor 22, the second paper sensor 23, and the belt sensors 24, 25 described above may be constructed of a transmissive or reflective optical sensor, a contact image sensor (CIS), or the like.

In addition, the printer 100 may be configured to include a meandering detection sensor that detects meandering of the first conveyance belt 8 and to correct the meandering of the first conveyance belt 8 on the basis of the detection result thereby.

The printer 100 further includes an operation panel 27, a storage unit 28, and a communication unit 29.

The operation panel 27 is an operation unit for accepting input of various settings by a user. For example, the user can operate the operation panel 27 to input information on size of the paper P to be set in the paper-feed cassette 2, that is, the size of the paper P to be conveyed by the first conveyance belt 8. The user can also command initiation of the print job by operating the operation panel 27.

The storage unit 28 is memory that stores an operation program for the control unit 110 and stores various types of information, and is configured to include read only memory (ROM), random access memory (RAM), non-volatile memory, or the like. The storage unit 28 stores the information that is set by using the operation panel 27 (for example, the information on the size of the paper P). The storage unit 28 also stores history information of the paper P that is used in the print job in the past (for example, the information on the size of the paper P that is used in the past), and the like.

The communication unit 29 is a communication interface used to exchange the information with an external device (for example, a personal computer (PC)). For example, when the user operates the PC and sends a print command and image data to the printer 100, the image data and the print command are input to the printer 100 via the communication unit 29. In the printer 100, the control unit 110 controls and causes the recording heads 17a to 17c to eject the ink on the basis of the image data, and the image can thereby be recorded on the paper P.

Furthermore, as illustrated in FIG. 3, the printer 100 has ink receiving units 31Y, 31M, 31C, 31K on an inner circumferential surface side of the first conveyance belt 8. When flushing is conducted by the recording heads 17a to 17c, each of the ink receiving units 31Y to 31K receives and collects the ink that is ejected from the recording heads 17a to 17c and passes through an opening 80 of the first conveyance belt 8. Accordingly, the ink receiving units 31Y to 31K are provided at positions facing the recording heads 17a to 17c of the line heads 11Y to 11K via the first conveyance belt 8, respectively. The ink that is collected in the ink receiving units 31Y to 31K is sent to a waste ink tank and is discarded, for example, but may not be discarded and may be reused.

Here, flushing means the ejection of the ink from the ink ejection ports 18 at different timing from timing that contributes to the image formation (image recording) on the paper P for a purpose of reducing or preventing clogging of the ink ejection ports 18 caused by drying of the ink. The control unit 110 controls conduction of flushing in the recording heads 17a to 17c.

The above-described second conveying unit 12 is configured to include a second conveyance belt 12a and a drier 12b. The second conveyance belt 12a is stretched by two of a drive roller 12c and a driven roller 12d. The paper P, which is conveyed by the first conveying unit 5, and on which the image is recorded by the ink ejection by the recording unit 9, is conveyed by the second conveyance belt 12a, is dried by the drier 12b during the conveyance, and is then conveyed to the above-described decurler unit 14.

[2. Details of First Conveyance Belt]

(2-1. Configuration Example of First Conveyance Belt)

Next, a description will be made on details of the first conveyance belt 8 in the first conveying unit 5. FIG. 5 is a plan view illustrating a configuration example of the first conveyance belt 8. In this embodiment, a negative-pressure suction method is adopted to suction and convey the paper P onto the first conveyance belt 8 by negative-pressure suction. For this reason, the first conveyance belt 8 is provided with innumerable suction holes 8a, through each of which the suction air generated by the negative-pressure suction passes.

The first conveyance belt 8 is also provided with the opening group 82. The opening group 82 is a set of the openings 80, through each of which the ink ejected from each of the nozzles (the ink ejection ports 18) of the recording heads 17a to 17c passes during flushing. An opening area of the single opening 80 is larger than an opening area of the single suction hole 8a. The first conveyance belt 8 has the plurality of opening groups 82 in the conveyance direction (an A direction) of the paper P in one cycle, and has the six opening groups 82 in this embodiment. Here, one cycle means a period in which the first conveyance belt 8 makes the one round. When the opening groups 82 are distinguished from each other, the six opening groups 82 are referred to as opening groups 82A to 82F from a downstream side in the A direction. The above suction holes 8a are located between the opening group 82 and the opening group 82 that are adjacent to each other in the A direction. That is, in the first conveyance belt 8, the suction holes 8a are not formed in a region that overlaps the opening group 82 (around the openings 80).

In the one cycle of the first conveyance belt 8, the opening groups 82 are irregularly located in the A direction. That is, in the A direction, a distance between the opening group 82 and the opening group 82 that are adjacent to each other is not constant but varies. At this time, the maximum distance between the two adjacent opening groups 82 in the A direction (for example, a distance between the opening group 82A and the opening group 82B in FIG. 5) is longer than a length of the paper P in the A direction at the time when the paper P in the minimum printable size (for example, A4 size (horizontally placed)) is placed on the first conveyance belt 8.

The opening group 82 has an opening row 81. The opening row 81 is configured by aligning the plurality of openings 80 in the belt width direction (the paper width direction, the BB′ direction) that is orthogonal to the A direction. In the single opening group 82, the at least one opening row 81 is provided in the A direction, and the two opening rows 81 are provided in this embodiment. When the two opening rows 81 are distinguished from each other, one of them is set as an opening row 81a, and the other is set as an opening row 81b.

In the single opening group 82, the openings 80 in any of the opening rows 81 (for example, the opening row 81a) are shifted in the BB′ direction from the openings 80 in the other opening row 81 (for example, the opening row 81b) and are located in a manner to partially overlap the openings 80 in the other opening row 81 (for example, the opening row 81b) when seen in the A direction. In addition, in each of the opening rows 81, the plurality of openings 80 are located at equally-spaced intervals in the BB′ direction.

Since the plurality of opening rows 81 are aligned in the A direction to form the single opening group 82 as described above, a width of the opening group 82 in the BB′ direction is greater than a width of the recording heads 17a to 17c in the BB′ direction. Accordingly, the opening group 82 covers an entire ink ejection region in the BB′ direction of the recording heads 17a to 17c, and the ink ejected from all the ink ejection ports 18 in the recording heads 17a to 17c during flushing passes through any of the openings 80 in the opening group 82.

From what have been described so far, it can be said that the first conveyance belt 8 has the opening groups 82 at the plurality of positions at the different intervals in the A direction as the conveyance direction, and each of the opening groups 82 includes the openings 80, through which the ink ejected from the recording heads 17a to 17c passes during flushing.

(2-2. Regarding Patterns of Opening Groups Used During Flushing)

In this embodiment, while the paper P is conveyed by using the first conveyance belt 8, the control unit 110 controls the recording heads 17a to 17c on the basis of the image data sent from the external device (for example, PC). In this way, the image is recorded on the paper P. At the time, the recording heads 17a to 17c conduct flushing between the paper P and the paper P that are conveyed (flushing between sheets of the paper), so as to reduce or prevent clogging of the ink ejection ports 18.

Here, in this embodiment, the control unit 110 determines the pattern (the combination) in the A direction of the plurality of opening groups 82 that are used during flushing in the one cycle of the first conveyance belt 8 according to the size of the paper P to be used. The control unit 110 can recognize the size of the paper P to be used on the basis of the information stored in the storage unit 28 (the size information of the paper P that is input through the operation panel 27a). The pattern of the opening group 82 is literally distinguished from a placement pattern of the paper P, which will be described below.

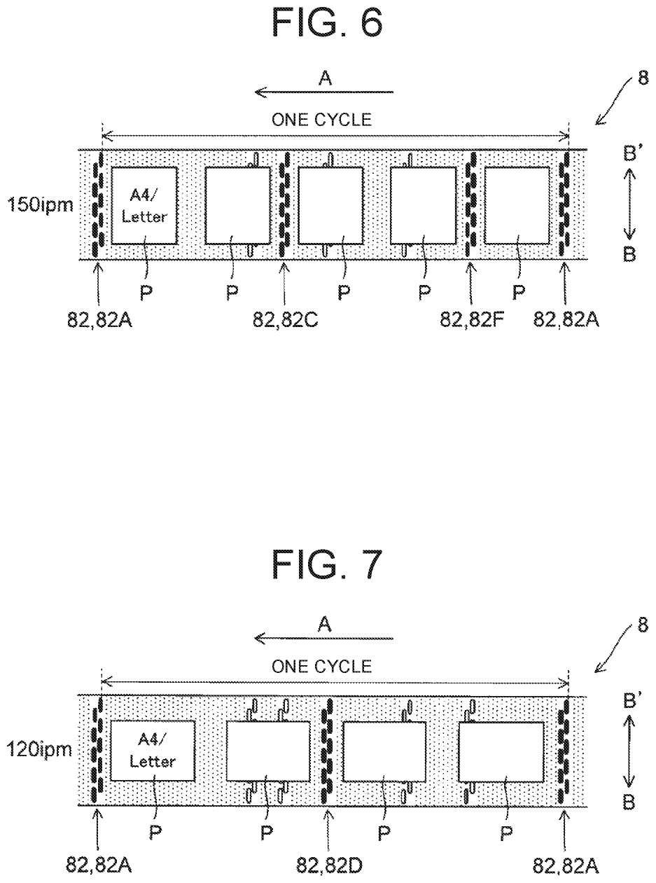

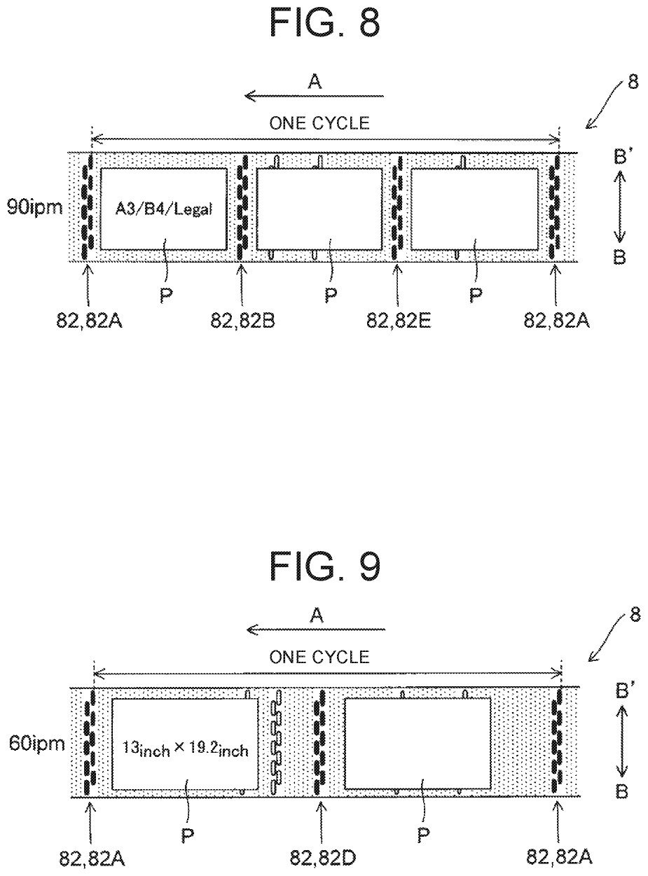

FIG. 6 to FIG. 9 each illustrate an example of the pattern of the opening group 82 per paper P in the different size. For example, in the case where the paper P to be used is in the A4 size (horizontally placed) or in letter size (horizontally placed), the control unit 110 selects a pattern of the opening groups 82 illustrated in FIG. 6. That is, of the six opening groups 82 illustrated in FIG. 5, the control unit 110 selects, as the opening groups 82 used for flushing, the opening groups 82A, 82C, 82F. In the case where the paper P to be used is in the A4 size (longitudinally placed) or in the letter size (longitudinally placed), as illustrated in FIG. 7, of the six opening groups 82, the control unit 110 selects, as the opening groups 82 used for flushing, the opening groups 82A, 82D. In the case where the paper P to be used is in A3 size, B4 size, or legal size (longitudinally placed in any of the cases), as illustrated in FIG. 8, of the six opening groups 82, the control unit 110 selects, as the opening groups 82 used for flushing, the opening groups 82A, 82B, 82E. In the case where the paper P to be used is in size of 13 inches×19.2 inches, as illustrated in FIG. 9, of the six opening groups 82, the control unit 110 selects, as the opening group 82 used for flushing, the opening groups 82A, 82D. In each of the drawings, the openings 80 in the opening groups 82 that belong to the above pattern are illustrated in black for convenience.

Then, the control unit 110 causes the recording heads 17a to 17c to conduct flushing at such timing that the opening groups 82 located in the determined pattern face the recording heads 17a to 17c due to the movement of the first conveyance belt 8. Here, a moving speed (a paper conveyance speed) of the first conveyance belt 8, the distance between two each of the opening groups 82A to 82E, and a positional relationship between the first conveyance belt 8 and each of the recording heads 17a to 17c and the belt sensor 24, 25 are all known. Accordingly, for example, when the opening group 82B and the opening group 82C with the shortest distance therebetween in the A direction in the first conveyance belt 8 are considered as the reference specifying portion Mref indicative of the reference for the one round of the belt, and when the belt sensor 24 or 25 detects passing of the reference specifying portion Mref due to the movement of the first conveyance belt 8, it is understood when each of the opening groups 82A to 82E passes the position facing the recording heads 17a to 17c several seconds after a time point of such detection. Thus, based on the detection result by the belt sensor 24 or 25, the control unit 110 can cause the recording heads 17a to 17c to conduct flushing at such timing that the opening groups 82 located in the above-determined pattern face the recording heads 17a to 17c.

(2-3. Regarding Paper Placement Pattern)

The control unit 110 controls supply of the paper P to the first conveyance belt 8 in a manner to shift the paper P in the A direction from the opening groups 82 that are located in the above determined pattern. More specifically, the control unit 110 supplies the paper P between the plurality of opening groups 82, which are aligned in the A direction in the above pattern, on the first conveyance belt 8 by the resist roller pair 13.

For example, in the case where the paper P to be used is in the A4 size (horizontally placed) or in the letter size (horizontally placed), as illustrated in FIG. 6, the control unit 110 controls the resist roller pair 13 to supply the paper P to the first conveyance belt 8 at specific supply timing such that, on the first conveyance belt 8, two sheets of the paper P are arranged between the opening group 82A and the opening group 82C, two sheets of the paper P are arranged between the opening group 82C and the opening group 82F, and one sheet of the paper P is arranged between the opening group 82F and the opening group 82A in the next cycle. At this time, the control unit 110 controls the resist roller pair 13 to supply the paper P to the first conveyance belt 8 such that, on the first conveyance belt 8, each sheet of the paper P is arranged at the position away from respective one of the opening groups 82A, 82C, 82F, which are arranged in the above pattern, by a specific distance or longer in the A direction (including both directions on the upstream side and the downstream side). Here, the specific distance is set to 10 mm as an example.

Here, the control unit 110 can determine the supply timing of the paper P by the resist roller pair 13 on the basis of the detection result by the belt sensor 24 or 25. For example, when the belt sensor 25 detects passing of the reference specifying portion Mref due to the movement of the first conveyance belt 8, the control unit 110 can determine timing which is several seconds after the time point of such detection and at which the paper P is supplied to the first conveyance belt 8 by the resist roller pair 13, so as to be able to arrange the paper P at each of the positions illustrated in FIG. 6. Accordingly, the control unit 110 determines the supply timing of the paper P on the basis of the detection result by the belt sensor 25, and controls the resist roller pair 13 such that the paper P is supplied at the determined supply timing. In this way, the paper P can be arranged at each of the positions illustrated in FIG. 6 on the first conveyance belt 8 substantially at equally-spaced intervals. In the example illustrated in FIG. 6, five sheets of the paper P can be conveyed in the one cycle of the first conveyance belt 8, 150 images per minute (ipm) can be achieved as number of printed sheets (productivity) per minute of the paper P.

In the case where the paper P to be used is in the A4 size (longitudinally placed) or in the letter size (longitudinally placed), as illustrated in FIG. 7, the control unit 110 controls the resist roller pair 13 to supply the paper P to the first conveyance belt 8 at the specific supply timing such that, on the first conveyance belt 8, two sheets of the paper P are arranged between the opening group 82A and the opening group 82D and two sheets of the paper P are arranged between the opening group 82D and the opening group 82A in the next cycle. In the example illustrated in FIG. 7, four sheets of the paper P can be conveyed in the one cycle of the first conveyance belt 8, and the productivity of 120 ipm can be achieved.

In the case where the paper P to be used is in A3 size, B4 size, or the legal size (longitudinally placed in any case), as illustrated in FIG. 8, the control unit 110 controls the resist roller pair 13 to supply the paper P to the first conveyance belt 8 at the specific supply timing such that, on the first conveyance belt 8, one sheet of the paper P is arranged between the opening group 82A and the opening group 82B, one sheet of the paper P is arranged between the opening group 82B and the opening group 82E, and one sheet of the paper P is arranged between the opening group 82E and the opening group 82A in the next cycle. In the example illustrated in FIG. 8, three sheets of the paper P can be conveyed in the one cycle of the first conveyance belt 8, and the productivity of 90 ipm can be achieved.

In the case where the paper P to be used is in the size of 13 inches×19.2 inches, as illustrated in FIG. 9, the control unit 110 controls the resist roller pair 13 to supply the paper P to the first conveyance belt 8 at the specific supply timing such that, on the first conveyance belt 8, one sheet of the paper P is arranged between the opening group 82A and the opening group 82D and one sheet is the paper P is arranged between the opening group 82D and the opening group 82A in the next cycle. In the example illustrated in FIG. 9, two sheets of the paper P can be conveyed in the one cycle of the first conveyance belt 8, and the productivity of 60 ipm can be achieved.

That is, as illustrated in FIG. 6 to FIG. 9, the pattern of the opening groups 82 used for flushing is determined according to the size of the paper P to be used, and the placement pattern of the paper P that is shifted in the A direction from the opening group 82 is determined. From the above, it can be said that the placement pattern of the paper P, which is placed on the first conveyance belt 8, is determined according to the size of the paper to be used.

The control unit 110 causes the recording heads 17a to 17c to eject the ink at the timing at which each of the paper P faces the recording heads 17a to 17c due to the movement of the first conveyance belt 8, so as to be able to form the image on each of the paper P. The timing at which each of the paper P faces the recording heads 17a to 17c is determined on the basis of the detection result of the paper P by the second paper sensor 23 (see FIG. 4).

(2-4. Regarding Stop Control For First Conveyance Belt After Completion of Print Job)

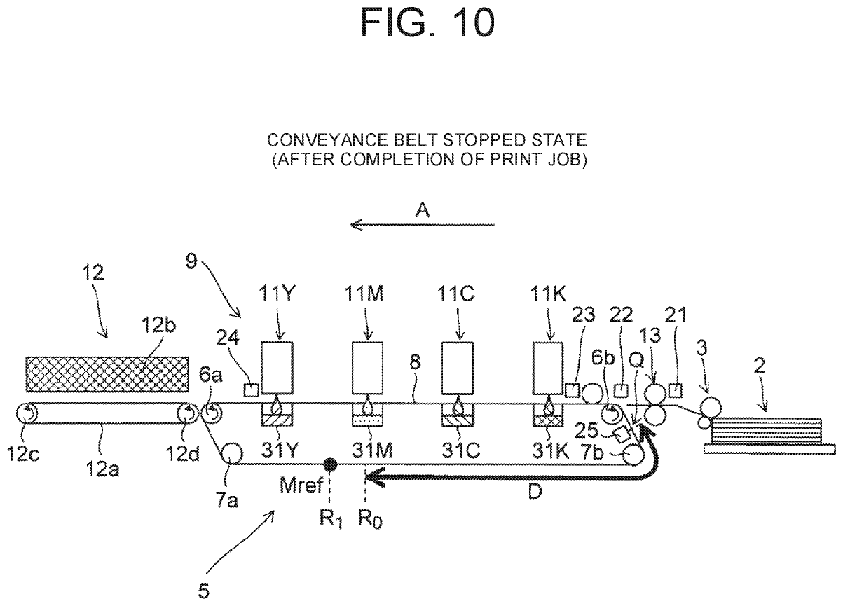

As illustrated in FIG. 6 to FIG. 9, when the image formation (the print job) on the paper P, which is placed on the first conveyance belt 8, is completed, the control unit 110 controls the drive roller 6a to stop the first conveyance belt 8. FIG. 10 schematically illustrates an example of the position (indicated by a black circle for convenience) of the reference specifying portion Mref in a stopped state of the first conveyance belt 8 after the printing job is completed.

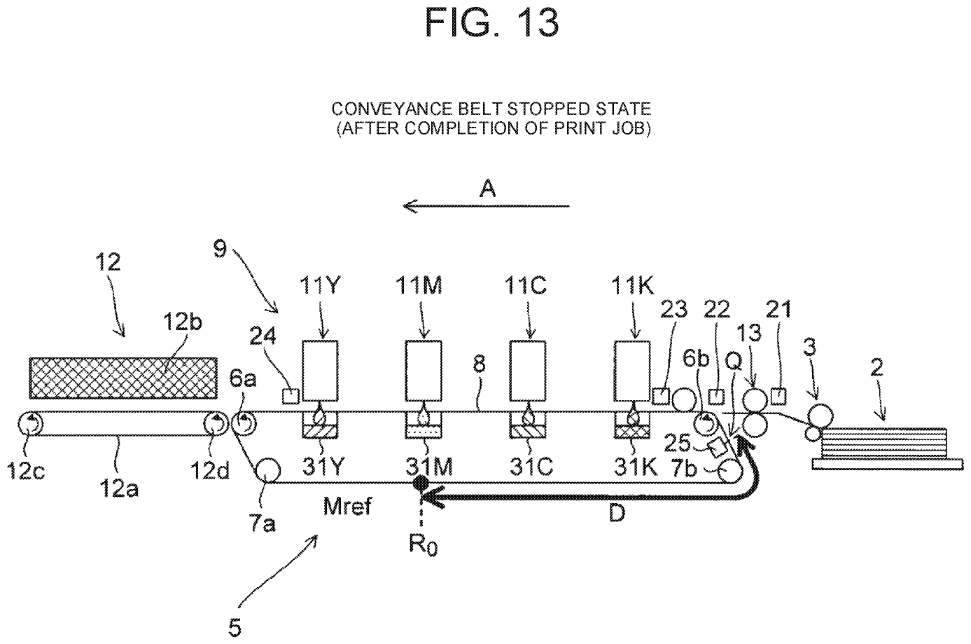

In this embodiment, after the completion of the print job, the control unit 110 controls the drive roller 6a and stops the first conveyance belt 8 such that the reference specifying portion Mref of the first conveyance belt 8 is stopped at a position R₁ that is on an upstream side in the conveyance direction (the A direction) of the first conveyance belt 8 from a detecting position Q of the belt sensor 25 by a particular distance D or longer. In FIG. 10, when the position on the upstream side in the A direction of the first conveyance belt 8 from the detecting position Q of the belt sensor 25 by the particular distance D is set as R₀, the position R₁ may be the same as the position R₀ (see FIG. 13), and this point will be described below.

Here, the particular distance D described above is a distance (mm) for which the first conveyance belt 8 moves until the first conveyance belt 8 reaches a specific conveyance speed V₀ (mm/sec) after the first conveyance belt 8 in the stopped state starts moving by driving of the drive roller 6a. As the specific conveyance speed V₀, for example, several hundred mm/sec can be considered. In addition, it is assumed that the control unit 110 recognizes, in advance, timing at which driving of the drive roller 6a should be stopped several seconds after the completion of the print job by the recording heads 17a to 17c (in particular, the line head 11Y) and after completion of the conveyance of the paper P, on which the print job has been performed, to the downstream side (for example, the conveyance to the second conveying unit 12), so as to make the reference specifying portion Mref to reach the position R₁.

For convenience of the description below, of the two print jobs that are sequentially performed in a timely manner, the print job that is performed first will also be referred to as a “former job”, and the print job that is performed later will also be referred to as a “latter job”.

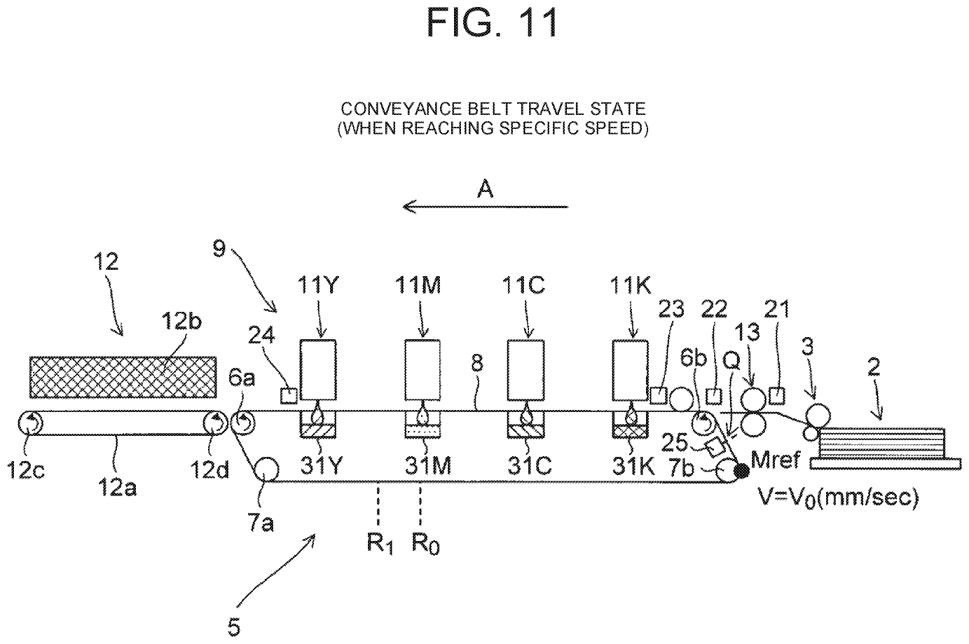

In a state where the former job is completed and the first conveyance belt 8 is stopped as illustrated in FIG. 10, when the initiation of the latter job is commanded through the operation of the operation panel 27 or by receiving a command from the external PC, for example, the control unit 110 controls the drive roller 6a, and the first conveyance belt 8 can thereby start moving. At this time, the first conveyance belt 8 starts moving from the state where the reference specifying portion Mref is stopped at the position R₁ on the upstream side of the detecting position Q of the belt sensor 25 by the particular distance D or longer. Accordingly, in the case where the first conveyance belt 8 starts moving, as illustrated in FIG. 11, the first conveyance belt 8 reaches the specific conveyance speed V₀ before the reference specifying portion Mref reaches the detecting position Q, that is, at a time point at which the reference specifying portion Mref moves from the position R₁ for the distance D. Thus, when the reference specifying portion Mref reaches the detecting position Q due to the movement of the first conveyance belt 8, the first conveyance belt 8 has already reached the specific conveyance speed V₀.

In this way, the control unit 110 can promptly start controlling the resist roller pair 13 on the basis of the detection result of the reference specifying portion Mref by the belt sensor 25. Then, the paper P can be supplied from the resist roller pair 13 to the first conveyance belt 8 at the specific timing such that the paper P is placed at the position at which the specific positional relationship with the reference specifying portion Mref illustrated in any of FIG. 6 to FIG. 9 is established on the first conveyance belt 8.

Here, for example, in the case where the first conveyance belt 8 has not reached the specific conveyance speed V₀ (=a supply speed of the paper P that is supplied from the resist roller pair 13) at the time when the reference specifying portion Mref reaches the detecting position Q, the conveyance speed of the first conveyance belt 8 no longer corresponds to the supply speed of the paper P. As a result, even in the case where it is desired to place the paper P at the specific position on the first conveyance belt 8 as illustrated in any of FIG. 6 to FIG. 9, such placement becomes difficult. Accordingly, in this case, the first conveyance belt 8 has to move (rotate) even further until the first conveyance belt 8 reaches the specific conveyance speed V₀ by driving of the drive roller 6a. While the first conveyance belt 8 further rotates, just as described, the resist roller pair 13 stops supplying the paper P to the first conveyance belt 8. As a result, there is a delay in the supply of the paper P from the resist roller pair 13 to the first conveyance belt 8.

In this embodiment, as described above, when the initiation of the latter job is commanded, the control unit 110 promptly starts controlling the resist roller pair 13 on the basis of the detection result of the reference specifying portion Mref by the belt sensor 25 and can thereby supply the paper P to the first conveyance belt 8. For this reason, thereafter, it is possible to promptly form the image by ejecting the ink from the recording heads 17a to 17c onto the paper P, which is placed on the first conveyance belt 8. As a result, compared to control for causing the first conveyance belt 8 to move further when the first conveyance belt 8 does not reach the specific conveyance speed V₀ at the detecting position Q, the latter job can be completed early.

Here, in the case where a distance from the detecting position Q to the position R₁ along a movement track of the first conveyance belt 8 is excessively long, and the first conveyance belt 8 in the stopped state starts moving in response to the initiation command of the latter job, the first conveyance belt 8 reaches the specific conveyance speed V₀ at a time point at which the reference specifying portion Mref reaches a position that is on the further upstream side of the detecting position Q. In this case, a wasteful period is generated from the time point at which the first conveyance belt 8 reaches the specific conveyance speed V₀ to the time point at which the reference specifying portion Mref reaches the detecting position Q. This can delay the detection of the reference specifying portion Mref by the belt sensor 25 and can also be a cause of the delay in the initiation of the control of the resist roller pair 13 that is based on the detection result of the reference specifying portion Mref. In consideration of such a point, the distance from the detecting position Q to the position R₁ along the movement track of the first conveyance belt 8 is desirably equal to or shorter than a track length of the first conveyance belt 8, and is further desired to be equal to or shorter than half the track length of the first conveyance belt 8.

In the configuration that the first conveyance belt 8 has the plurality of opening groups 82 for flushing, the reference specifying portion Mref is constructed of the combination of the two adjacent opening groups 82B, 82C in the conveyance direction. In this case, the reference specifying portion Mref can be formed by effectively using the opening groups 82 provided in the first conveyance belt 8. In addition, compared to a configuration that the reference specifying portion is separately provided from the opening group 82 in the first conveyance belt 8, the configuration of the first conveyance belt 8 is simplified. Here, the opening groups 82 that constitute the reference specifying portion Mref may be a combination of any two of the adjacent opening groups 82 in the conveyance direction, and thus are not limited to the combination of the opening groups 82B, 82C described above.

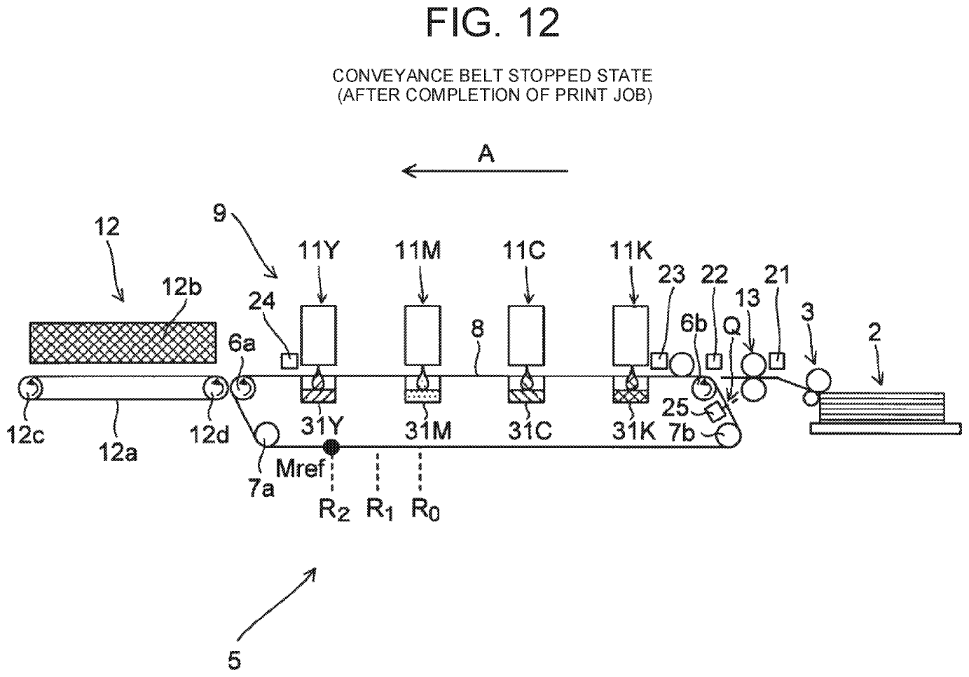

FIG. 12 schematically illustrates another example of the position of the reference specifying portion Mref in the stopped state of the first conveyance belt 8 after the completion of the former job. The control unit 110 may control the drive roller 6a to stop the first conveyance belt 8 such that the position of the reference specifying portion Mref is shifted to the upstream side or the downstream side in the A direction every time the print job is completed. For example, the control unit 110 may stop the first conveyance belt 8 such that the reference specifying portion Mref stops at the position R₁ after the completion of the first print job (see FIG. 10), and may stop the first conveyance belt 8 such that the reference specifying portion Mref stops at a position R₂ on an upstream side of the position R₁ in the A direction after the completion of the next second print job (see FIG. 12). For the print jobs onward, the stop position of the reference specifying portion Mref may alternately be switched between the position R₁ and the position R₂ every time the print job is completed.

For example, in the case where the first conveyance belt 8 is stopped at the same position (for example, the position R₁) for a long time, a state where a contact portion of the first conveyance belt 8 with a circumferential surface of the drive roller 6a or the like is bent along the circumferential surface continues for the long time. As a result, a “bent” mark is formed in the contact portion of the first conveyance belt 8. The formation of such a local bending mark possibly inhibits the smooth movement of the first conveyance belt 8.

As described above, the control unit 110 controls the drive roller 6a to stop the first conveyance belt 8 such that the stop position of the reference specifying portion Mref is shifted to the upstream side or the downstream side every time the print job is completed. In this way, it is possible to reduce a chance of the formation of the local “bent” mark in the first conveyance belt 8 as much as possible. Thus, it is possible to avoid degradation of movement performance of the first conveyance belt 8 caused by marking.

In the above example, the stop position of the reference specifying portion Mref is switched between the position R₁ and the position R₂ every time the print job is completed. However, the stop position of the reference specifying portion Mref may be switched between a position R₀ and the position R₁ or may be switched between the position R₀ and the position R₂. Alternatively, the stop position of the reference specifying portion Mref may be switched in three stages of the position R₁, the position R₂, and a position R₃ every time the print job is completed.

Here, as long as the stop position of the reference specifying portion Mref is shifted to the upstream side from the position R₀ and in the case where the initiation of the latter job is commanded, the first conveyance belt 8 has already reached the specific conveyance speed V₀ at the time point at which the reference specifying portion Mref reaches the detecting position Q. Thus, it is possible to suppress extension of a period from the initiation command of the latter job to a time point at which printing can actually be started.

The stop position of the reference specifying portion Mref may not be shifted after the completion of the single print job. For example, the stop position of the reference specifying portion Mref may be shifted after the completion of the specific number of the print jobs or after a lapse of a specific time.

FIG. 13 schematically illustrates further another example of the position of the reference specifying portion Mref in the stopped state of the first conveyance belt 8 after the completion of the former job. As illustrated in FIG. 13, the control unit 110 may control the drive roller 6a to stop the first conveyance belt 8 such that, after the completion of the former job, the reference specifying portion Mref always stops at the position R₀ (regardless of which print job is completed) that is on the upstream side of the detecting position Q by the particular distance D.

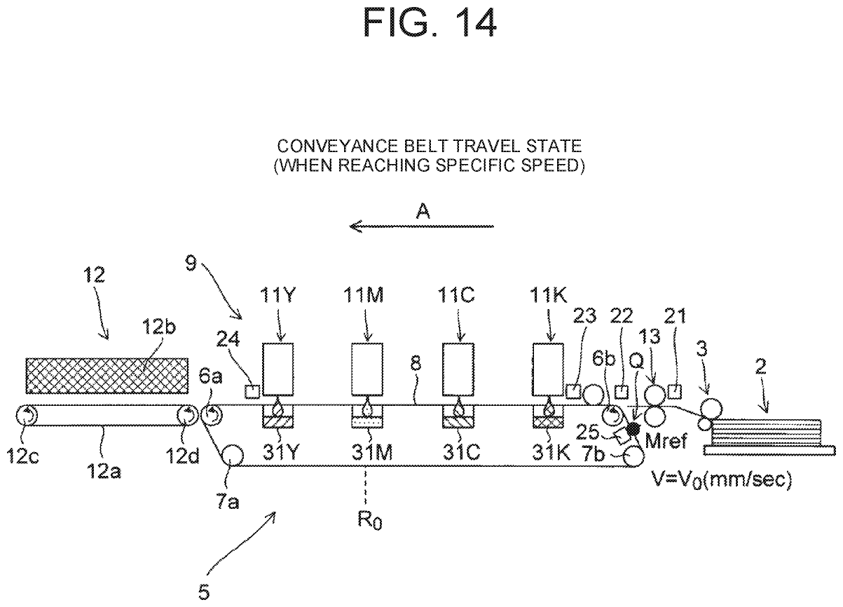

In this case, when the initiation of the latter job is commanded, the control unit 110 controls the drive roller 6a and starts the movement of the stopped first conveyance belt 8. At this time, the reference specifying portion Mref starts moving from the above position R₀. Thus, as illustrated in FIG. 14, at the time point at which the reference specifying portion Mref reaches the detecting position Q (at a time point at which the reference specifying portion Mref moves from the position R₀ for the distance D), the first conveyance belt 8 reaches the specific conveyance speed V₀. In this way, the belt sensor 25 detects the reference specifying portion Mref in the shortest time from the initiation of the movement of the first conveyance belt 8, and the control unit 110 immediately starts controlling the resist roller pair 13 on the basis of the detection result. Thus, the paper P can promptly be supplied to the first conveyance belt 8. Accordingly, for example, compared to the above-described control for stopping the reference specifying portion Mref at the position R₁, the distance of which on the upstream side from the detecting position Q is longer than the distance D, after the completion of the former job, it is possible to complete the latter job even earlier.

(2-5. Another Configuration Example of First Conveyance Belt)

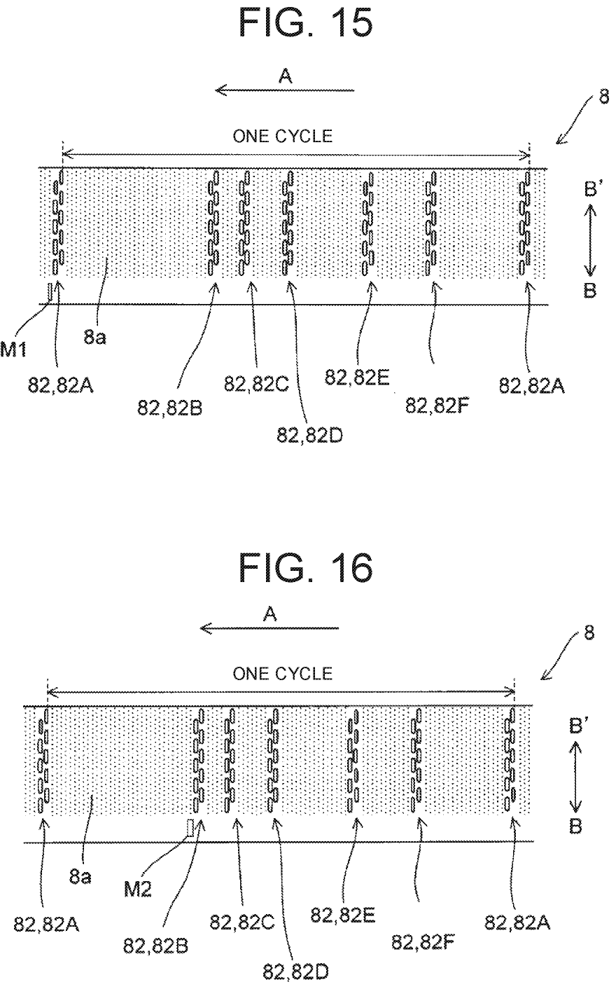

FIG. 15 is a plan view schematically illustrating another configuration of the first conveyance belt 8. The first conveyance belt 8 may have a reference mark M1 as the reference specifying portion in addition to the opening groups 82 illustrated in FIG. 5. The reference mark M1 is located on one end side in the belt width direction (the BB′ direction) of the first conveyance belt 8 in a manner to correspond to the opening group 82A. That is, on the first conveyance belt 8, the reference mark M1 is located in a specific positional relationship with the particular opening group 82A of the plurality of opening groups 82. The above specific positional relationship refers to, for example, a relationship in which a position of the reference mark M1 is shifted to the downstream side in the A direction by a specific distance from a position aligned with the opening group 82A in the belt width direction. However, it is needless to say that the above specific positional relationship is a positional relationship in which the reference mark M1 is aligned with the opening group 82A in the belt width direction.

The reference mark M1 is formed in a rectangular shape in a plan view (when seen in a perpendicular direction to a plane including the A direction and the BB′ direction), for example. However, the reference mark M1 is not limited to such a shape and may be formed in another shape (for example, triangular). Such a reference mark M1 is formed as a hole, for example, but may be formed of a reflective member. The reflective member can be formed by using a seal or paint that has different surface reflectance from the first conveyance belt 8.

In this embodiment, as illustrated in FIG. 6 to FIG. 9, the paper P is sequentially supplied to the first conveyance belt 8 by the resist roller pair 13 such that the paper P is placed on the first conveyance belt 8 in the placement pattern that is determined according to the size. At this time, of the plurality of opening groups 82, the opening group 82A is the opening group 82 having the largest number of types (size) of the paper P that is placed on the immediate upstream side (for example, the position away from the opening group 82A by 10 to 20 mm) in the A direction. More specifically, regardless of whether the paper P is in the A4 size (horizontally placed), the letter size (horizontally placed), the A4 size (longitudinally placed), the letter size (longitudinally placed), the A3 size (longitudinally placed), the B4 size (longitudinally placed), the legal size (longitudinally placed), or the size in 13 inches×19.2 inches, the paper P is placed on the immediate upstream side of the particular opening group 82A on the first conveyance belt 8.

Since the reference mark M1 is in the specific positional relationship with the particular opening group 82A on the first conveyance belt 8 as described above, in regard to almost all the size of the paper P to be used (all the size of the paper P in the above example), it is possible to promptly place the paper P on the immediate upstream side of the particular opening group 82A on the first conveyance belt 8 to perform the latter job by controlling the resist roller pair 13 on the basis of the detection result of the reference mark M1. As a result, the latter job can be completed early. Thus, for example, even in the case where the paper P in the different size is used for each print job, each of the print jobs can be completed early, and the paper P in the different size can be handled easily.

In addition, regardless of the size of the paper P to be used, the paper P is actually supplied to and placed on the first conveyance belt 8 after the belt sensor 25 detects the reference mark M1, the first conveyance belt 8 further moves, and the particular opening group 82A passes a point at which the opening group 82A meets the paper P supplied from the resist roller pair 13. Accordingly, when the reference mark M1, which is in the specific positional relationship with such a particular opening group 82A, is detected, it becomes easy to continuously (sequentially) place the paper P in any size with the particular opening group 82A being the reference by controlling the resist roller pair 13 on the basis of the detection result of the reference mark M1.

(2-6. Further Another Configuration Example of First Conveyance Belt)

FIG. 16 is a plan view schematically illustrating further another configuration of the first conveyance belt 8. The first conveyance belt 8 may have a reference mark M2 as the reference specifying portion in addition to the opening groups 82 illustrated in FIG. 5. The reference mark M2 is located on the one end side in the belt width direction (the BB′ direction) of the first conveyance belt 8 in a manner to correspond to the opening group 82B. That is, on the first conveyance belt 8, the reference mark M2 is located in a specific positional relationship with the particular opening group 82B of the plurality of opening groups 82. The above specific positional relationship refers to, for example, a relationship in which a position of the reference mark M2 is shifted to the downstream side in the A direction by a specific distance from a position aligned with the opening group 82B in the belt width direction. However, it is needless to say that the above specific positional relationship may be a positional relationship in which the reference mark M2 is aligned with the opening group 82B in the belt width direction.

The reference mark M2 is formed in the rectangular shape in a plan view, for example. However, the reference mark M2 is not limited to this shape and may be formed in another shape (for example, triangular). Similar to the above-described reference mark M1, such a reference mark M2 is formed as a hole or formed of the reflective member.

For example, it can be said that, in the printer 100 in which frequent use of the paper P in the A3 size is known in advance, in the placement pattern of the paper P in the A3 size illustrated in FIG. 8, in the case where the position of the opening group 82 that does not overlap the paper P (is shifted in the A direction), that is, the position of any of the opening groups 82A, 82B, 82E used for flushing can be detected immediately after the initiation command of the latter job, there is a high possibility that the latter job is completed early (because there is a high possibility that the paper P in the A3 size is also used for the latter job).

The above reference mark M2 is located in the specific positional relationship with the particular opening group 82B on the first conveyance belt 8. In addition, the particular opening group 82B corresponds to any of the opening groups 82, of which the paper P is located on the immediate upstream side in the A direction when the paper P is placed on the first conveyance belt 8 in the placement pattern that corresponds to the most frequently used size (the A3 size in the above example) of the paper P set in advance. In this case, after the initiation of the latter job is commanded, the control unit 110 promptly controls the resist roller pair 13 on the basis of the detection result of the reference mark M2 by the belt sensor 25, and can promptly place the paper P in the most frequently used size at the position on the immediate upstream side of the particular opening group 82 on the first conveyance belt 8. As a result, in regard to the paper P in the frequently used size, the latter job can promptly be performed and completed early, and convenience thereof can be improved.

The description has been made herein on the opening group 82B as the particular opening group of the opening groups 82A, 82B, 82E, each of which does not overlap the paper P in the placement pattern, on the first conveyance belt 8 when it is assumed that the paper P in the A3 size is used most frequently. However, the remaining opening group 82A or 82E may be set as the particular opening group, and a reference mark may be provided to the first conveyance belt 8 in a manner to establish a specific positional relationship with this particular opening group. Also, in the case where the paper P in another size is used most frequently, similar to the above, in the placement pattern of the paper P that is used most frequently, any of the opening groups 82, which do not overlap the paper P, on the first conveyance belt 8 may be set as the particular opening group, and the reference mark may be provided to the first conveyance belt 8 in a manner to establish the specific positional relationship with the particular opening group.

(2-7. Yet Another Configuration Example of First Conveyance Belt)

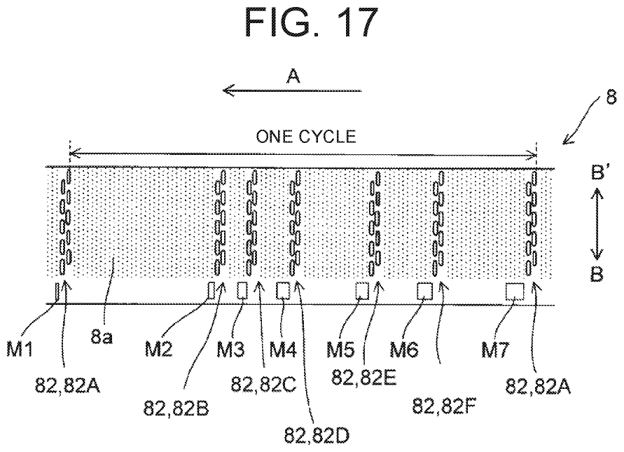

FIG. 17 is a plan view schematically illustrating yet another configuration of the first conveyance belt 8. The first conveyance belt 8 may have the reference marks M1 to M6 as the reference specifying portions in addition to the opening groups 82 illustrated in FIG. 5. The reference marks M1 to M6 are located on the one end side in the belt width direction (the BB′ direction) of the first conveyance belt 8 in a manner to correspond to the opening groups 82A to 82F, respectively. That is, the reference marks M1 to M6 are provided at a plurality of positions in the A direction on the first conveyance belt 8 in a manner to establish specific positional relationships with the opening groups 82A to 82F, respectively. Each of the above specific positional relationships refers to, for example, a relationship in which the position of respective one of the reference marks M1 to M6 is shifted to the downstream side by the specific distance from the position aligned with respective one of the opening groups 82A to 82F in the belt width direction. However, it is needless to say that the above specific positional relationship may be a positional relationship in which respective one of the reference marks M1 to M6 is aligned with respective one of the opening groups 82A to 82F in the belt width direction.

The reference marks M1 to M6 are formed in rectangular shapes, widths of which in the A direction differ from each other, in the plan view, for example. In this way, the belt sensor 25 can distinguish and detect the reference marks M1 to M6 from each other in conjunction with the movement of the first conveyance belt 8, and can distinguish and detect positions of the corresponding opening groups 82A to 82F (passing of the opening groups 82A to 82F). Each of the reference marks M1 to M6 only needs to have such a shape that can be distinguished and detected by the belt sensor 25, and thus is not limited to have the rectangular shape illustrated in FIG. 15. Similar to the above, each of such reference marks M1 to M6 is formed as the hole or formed of the reflective member.

In the case where the first conveyance belt 8 having such reference marks M1 to M6, which are mutually distinguished as described above, is used, the control unit 110 may control the drive roller 6a to stop the first conveyance belt such that, after the completion of the former job, any of the opening groups 82, which corresponds to any one of the reference marks, of the plurality of opening groups 82A to 82F stops at the position (the position R₁ or the like) on the upstream side in the A direction of the first conveyance belt 8 from the detecting position Q of the belt sensor 25 by the particular distance D or longer. In this case, when the initiation of the latter job is commanded and the paper P in any of the size is at least used, it is possible to always exert an effect of completing the latter job early.

Here, of the plurality of opening groups 82A to 82F, any of the reference marks, each of which stops at the position R₁ or the like, may be the reference mark M1 that corresponds to the opening group 82A having the largest number of the types (the size) of the paper P located on the immediate upstream side in the A direction in the placement pattern per size of the paper P.

In this case, after the initiation command of the latter job, the stopped first conveyance belt 8 starts moving. Then, at the time point at which the reference mark M1 reaches the detecting position Q, the first conveyance belt 8 has reached the specific conveyance speed V₀. Accordingly, the control unit 110 promptly controls the resist roller pair 13 on the basis of the detection result of the reference mark M1 by the belt sensor 25 and, for almost all the size of the paper P, promptly places the paper P on the immediate upstream side of the particular opening group 82A on the first conveyance belt 8 to perform the latter job. In this way, the latter job can promptly be completed. Thus, similar to the case of the control in (2-5) described above, even in the case where the paper P in the different size is used for each print job, it is possible to promptly complete the print job on the paper P in each of the size, and the paper P in the different size can easily be handled.

Any of the above reference marks, each of which is stopped at the position R₁ or the like, may be the reference mark that corresponds to any opening group 82 of the plurality of opening groups 82A to 82F, of which the paper P is located on the immediate upstream side in the A direction when the paper P in the size, which is set in advance as being most frequently used, is placed on the first conveyance belt 8 on the basis of any of the placement patterns illustrated in FIG. 6 to FIG. 9. For example, in the case where the paper P in the A3 size is set in advance as being most frequently used, the control unit 110 controls the drive roller 6a to stop the first conveyance belt 8 such that the reference mark (any of the reference marks M1, M2, M5) stops at the position R₁ or the position R₀, and such a reference mark corresponds to any of the opening groups 82A, 82B, 82E, of which the paper P is located on the immediate upstream side in the A direction in the placement pattern illustrated in FIG. 8.

For example, it is assumed that, after the completion of the former job, the first conveyance belt 8 is stopped such that the reference mark M2 is stopped at the position R₀. When the initiation of the latter job is commanded in this state, the stopped first conveyance belt 8 starts moving. Then, at the time point at which the reference mark M2 reaches the detecting position Q, the first conveyance belt 8 has reached the specific conveyance speed V₀. Accordingly, the control unit 110 promptly controls the resist roller pair 13 on the basis of the detection result of the reference mark M2 by the belt sensor 25, and promptly places the paper P in the A3 size, which is most frequently used, on the immediate upstream side of the particular opening group 82B on the first conveyance belt 8 to perform the latter job. In this way, the latter job can be completed early. As a result, similar to the case of the control in (2-6) described above, the latter job can promptly be performed and completed early on the paper P, which is most frequently used, and thus the convenience thereof can be improved.

In addition, any of the above reference marks, each of which is stopped at the position R₁ or the like, may be the reference mark that corresponds to any opening group 82 of the plurality of opening groups 82A to 82F, of which the paper P is located on the immediate upstream side in the A direction when the paper P in the most frequently used size, which determined on the basis of the past use history, is placed on the first conveyance belt 8 on the basis of any of the placement patterns illustrated in FIG. 6 to FIG. 9. For example, it is assumed that the control unit 110 determines that the frequency of use of the paper P in the A4 size (longitudinally placed) is the highest on the basis of information on the past use history stored in the storage unit 28. In this case, the control unit 110 controls the drive roller 6a to stop the first conveyance belt 8 such that the reference mark (the reference mark M1 or M4) corresponding to any of the opening groups 82A, 82D, of which the paper P is located on the immediate upstream side in the A direction, in the placement pattern illustrated in FIG. 7 is stopped at the position R₁ or the position R₀.

For example, it is assumed that, after the completion of the former job, the first conveyance belt 8 is stopped such that the reference mark M4 is stopped at the position R₀. When the initiation of the latter job is commanded in this state, the first conveyance belt 8 that has been stopped starts moving. Then, at the time point at which the reference mark M4 reaches the detecting position Q, the first conveyance belt 8 has reached the specific conveyance speed V₀. Accordingly, the control unit 110 promptly controls the resist roller pair 13 on the basis of the detection result of the reference mark M4 by the belt sensor 25, and promptly places the paper P in the most frequently used A4 size (longitudinally placed) on the immediate upstream side of the particular opening group 82D on the first conveyance belt 8 to perform the latter job. In this way, the latter job can be completed early. As a result, similar to the case of the control in (2-6) described above, in regard to the paper P in the size that is determined to be most frequently used on the basis of the past use history, the latter job can promptly be performed and completed early, and thus the convenience thereof can be improved.

Any of the above reference marks, each of which is stopped at the position R₁ or the like may be the reference mark that corresponds to any opening group 82 of the plurality of opening groups 82A to 82F, of which the paper P is located on the immediate upstream side in the A direction when the paper P is placed on the first conveyance belt 8 on the basis of the placement pattern corresponding to the size of the paper P, on which the former job has been performed, that is, the paper P, on which the formed job has been performed immediately before the first conveyance belt 8 is stopped. For example, in the case where the paper P in the A4 size (horizontally placed) is used in the former job (the use history is stored in the storage unit 28), the control unit 110 controls the drive roller 6a to stop the first conveyance belt 8 such that the reference mark (for example, the reference mark M1) stops at the position R₁ or the position R₀ when the paper P is placed on the first conveyance belt 8 in the placement pattern in FIG. 6 that corresponds to the A4 size (horizontally placed), and the reference mark corresponds to any (for example, the opening group 82A) of the opening groups 82A, 82C, 82F, of which the paper P is located on the immediate upstream side in the A direction.

It is understood from experience that, in the latter job that is performed sequentially after the completion of the former job, the paper P in the same size as the paper P used in the former job is frequently used. Accordingly, when the initiation of the latter job is commanded and the reference mark M1 reaches the detecting position Q due to the movement of the first conveyance belt 8, the control unit 110 can promptly control the resist roller pair 13 on the basis of the detection result of the reference mark M1 by the belt sensor 25. In this way, unless a size change of the paper P is specified, the paper P in the same size as the paper P used in the former job is promptly placed on the immediate upstream side of the particular opening group 82A on the first conveyance belt 8 to perform the latter job. As a result, the latter job can be completed early.

Any of the above reference marks, each of which is stopped at the position R₁ or the like, may be the reference mark that corresponds to any opening group of the plurality of opening groups 82A to 82F, of which the paper P is located on the immediate upstream side in the A direction when the paper P is placed on the first conveyance belt 8 on the basis of the placement pattern corresponding to the specified size of the paper P, in the case where the size of the paper P to be used in the latter job is specified in advance. For example, in the case where the size of the paper P to be used in the latter job is specified in advance as the A4 size (longitudinally placed) and such information is stored in the storage unit 28, the control unit 110 controls the drive roller 6a to stop the first conveyance belt 8 such that the reference mark (for example, the reference mark M4) stops at the position R₁ or the position R₀, and the reference mark corresponds to any (for example, the opening group 82D) of the opening groups 82A, 82D, of which the paper P is located on the immediate upstream side in the A direction when the paper P is placed on the first conveyance belt 8 in the placement pattern of the A4 size (longitudinally placed) illustrated in FIG. 7.

When the initiation of the latter job is commanded and the reference mark M4 reaches the detecting position Q due to the movement of the first conveyance belt 8, the control unit 110 promptly controls the resist roller pair 13 on the basis of the detection result of the reference mark M4 by the belt sensor 25. In this way, the paper P in the size that is specified in advance for the latter job is promptly placed on the immediate upstream side of the particular opening group 82D on the first conveyance belt 8, and the latter job is performed. As a result, the latter job can be completed early.

(2-8. Summary of Reference Specifying Portion of First Conveyance Belt)

The first conveyance belt 8 that has been used in (2-5) to (2-7) described so far can be described as follows. That is, the first conveyance belt 8 has the opening groups 82A to 82F, each of which includes the openings 80 through which the ink ejected from the recording heads 17a to 17c passes during flushing, at the plurality of positions at the different intervals in the A direction. The first conveyance belt 8 has, as the reference specifying portion indicative of the reference for the one round of the belt, the at least one reference mark (at least any one of the reference marks M1 to M6) that is located in the specific positional relationship with any of the opening groups 82A to 82F.

Even in the case where the first conveyance belt 8 is configured to have the reference mark, which is located in the specific positional relationship with at least any one of the opening groups 82A to 82F, in addition to the opening groups 82A to 82F for flushing, the first conveyance belt 8 starts moving from the stopped state in conjunction with the initiation command of the latter job, the belt sensor 25 detects the reference mark (for example, the reference mark M1) as the reference specifying portion, and the control unit 110 promptly controls the resist roller pair 13 on the basis of the detection result by the belt sensor 25. In this way, the paper P can promptly be supplied to the first conveyance belt 8. As a result, the commanded latter job can be completed early.

(3. Others)

The description has been made so far on the case where the paper P is suctioned onto and conveyed on the first conveyance belt 8 by the negative-pressure suction. However, the first conveyance belt 8 may electrically be charged, and the paper P is electrostatically suctioned onto and conveyed on the first conveyance belt 8 (an electrostatic suction method). Also, in this case, it is possible to adopt such a configuration that the first conveyance belt 8 is provided with a plurality of marks 90.

The description has been made so far on the example in which, as the inkjet recording device, the color printer is used to record the colored image by using the four colors of the ink. However, the configuration and the control in this embodiment can also be applied to a case where a monochrome printer is used to record a monochrome image by using the black ink.

The present disclosure can be used for the inkjet recording device such as an inkjet printer.

What is claimed is:

1. An inkjet recording device comprising:
a recording head that has a plurality of nozzles for ejecting ink;
an endless conveyance belt that conveys a recording medium to a position facing the recording head and has a reference specifying portion indicative of a reference of one round of the belt;
a drive roller that causes the conveyance belt to move in a conveyance direction of the recording medium;
a recording medium supply unit that supplies the recording medium onto the conveyance belt;
a reference detection sensor that detects the reference specifying portion; and
a control unit that controls the drive roller and the recording medium supply unit, wherein
the control unit controls the drive roller to stop the conveyance belt such that, after completion of a print job in which an image is formed by ejecting the ink to the recording medium from the recording head, the reference specifying portion of the conveyance belt is stopped at a position on an upstream side in the conveyance direction of the conveyance belt from a detecting position of the reference detection sensor by a particular distance or longer, and
the particular distance is a distance for which the conveyance belt moves until the conveyance belt reaches a specific conveyance speed since the conveyance belt in a stopped state starts moving by driving of the drive roller.

2. The inkjet recording device according to claim 1, wherein the control unit controls the drive roller to stop the conveyance belt such that, every time the print job is completed, the reference specifying portion of the conveyance belt is shifted to an upstream side or a downstream side in the conveyance direction.

3. The inkjet recording device according to claim 1, wherein the control unit controls the drive roller to stop the conveyance belt such that, after the completion of the print job, the reference specifying portion of the conveyance belt is stopped at the position on the upstream side in the conveyance direction of the conveyance belt from the detecting position of the reference detection sensor by the particular distance.

4. The inkjet recording device according to claim 1, wherein
the conveyance belt has opening groups each including an opening, through which the ink passes when the recording head conducts flushing for ejecting the ink at different timing from timing that contributes to the image formation on the recording medium, at a plurality of positions at different intervals in the conveyance direction, and
the reference specifying portion includes a combination of any two of the opening groups that are adjacent in the conveyance direction.

5. The inkjet recording device according to claim 1, wherein the conveyance belt has opening groups each including an opening, through which the ink passes when the recording head conducts flushing for ejecting the ink at different timing from timing that contributes to the image formation on the recording medium, at a plurality of positions at different intervals in the conveyance direction, and has, as the reference specifying portion, at least one reference mark that is located in a specific positional relationship with one of the opening groups.

6. The inkjet recording device according to claim 5, wherein
the recording medium is sequentially supplied to the conveyance belt by the recording medium supply unit such that the recording medium is placed on the conveyance belt in a placement pattern that is determined according to size of the recording medium,
on the conveyance belt, the reference mark is located in a specific positional relationship with a particular opening group of the plurality of opening groups, and
of the plurality of opening groups, the particular opening group is the opening group, of which the largest number of types of the recording mediums are located on an immediate upstream side in the conveyance direction among each of the placement patterns per size of the recording mediums.

7. The inkjet recording device according to claim 5, wherein
the recording medium is supplied to the conveyance belt by the recording medium supply unit such that the recording medium is placed on the conveyance belt in a placement pattern that is determined according to size of the recording medium,
on the conveyance belt, the reference mark is located in a specific positional relationship with a particular opening group of the plurality of opening groups, and
the particular opening group is any of the opening groups, of which the recording medium is located on an immediate upstream side in the conveyance direction when the recording medium is placed on the conveyance belt in a placement pattern that corresponds to the size of the recording medium, which is set in advance as being most frequently used.

8. The inkjet recording device according to claim 5, wherein
the recording medium is sequentially supplied to the conveyance belt by the recording medium supply unit such that the recording medium is placed on the conveyance belt in a placement pattern that is determined according to size of the recording medium,
on the conveyance belt, the reference mark is located in a specific positional relationship with each of the plurality of opening groups, and a plurality of the reference marks are provided in the conveyance direction and are distinguished from each other, and
the control unit controls the drive roller to stop the conveyance belt such that, after the completion of the print job, the reference mark corresponding to any of the plurality of opening groups stops at the position on the upstream side in the conveyance direction of the conveyance belt from the detecting position of the reference detection sensor by the particular distance or longer.

9. The inkjet recording device according to claim 8, wherein the reference mark is a reference mark that corresponds to, of the plurality of opening groups, an opening group, of which the largest number of types of the recording mediums are located on the immediate upstream side in the conveyance direction among each of the placement patterns per size of the recording mediums.

10. The inkjet recording device according to claim 8, wherein the reference mark is a reference mark that corresponds, of the plurality of opening groups, to any opening group, of which the recording medium in the size, which is set in advance as being most frequently used, is located on the immediate upstream side in the conveyance direction when the recording medium is placed on the conveyance belt on the basis of the placement pattern.

11. The inkjet recording device according to claim 8, wherein the reference mark is a reference mark that corresponds to, of the plurality of opening groups, any opening group, of which the recording medium in the size, which is determined on the basis of past use history as being most frequently used, is located on the immediate upstream side in the conveyance direction when the recording medium is placed on the conveyance belt on the basis of the placement pattern.

12. The inkjet recording device according to claim 8, wherein the reference mark is a reference mark that corresponds to, of the plurality of opening groups, any opening group, of which the recording medium, on which the print job is performed immediately before the conveyance belt is stopped, is located on the immediate upstream side in the conveyance direction when the recording medium is placed on the conveyance belt on the basis of the placement pattern corresponding to the size of the recording medium.

13. The inkjet recording device according to claim 8, wherein, in the case where size of a recording medium to be used for the next print job is specified in advance, the reference mark is a reference mark that corresponds to, of the plurality of opening groups, any opening group, of which the recording medium is located on the immediate upstream side in the conveyance direction when the recording medium is placed on the conveyance belt on the basis of the placement pattern corresponding to the size of the recording medium.
